(19) United States
(12) Patent Application Publication
(10) Pub. No.: US 2011/0229868 A1
(43) Pub. Date: Sep. 22, 2011

(54) ELECTRONIC CLASS SYSTEM

(76) Inventor: Chun-Mi Chu, Zhonghe City (TW)

(21) Appl. No.: 12/728,378

(22) Filed: Mar. 22, 2010

(51) Int. Cl. G09B 3/00

(52) U.S. Cl. 434/350

(57) ABSTRACT

An electronic class system includes a class certifying unit for certifying a plurality of students of a class, a class information displaying unit for displaying a school name and a grade level of the class, a class student displaying unit for displaying a plurality of student images of the class, and the student images are linked to a student information group; and a class message announcing unit for displaying at least one message title. Therefore, the electronic class system can save expenses of students and allows the students to update their correspondence data and keep in contact with each other anytime.

### FIELD OF THE INVENTION

The present invention relates to an electronic class system, in particular to an electronic class system that saves students' expenses and allows students to update their correspondence information and keep in contact with each other anytime.

### BACKGROUND OF THE INVENTION

Student life is an integral part of our life, and profound passion and friendship are usually established between students and between students and teachers during the period of two or more years in schools. However, it is difficult for students to keep in contact with each other after the students are graduated, due to factors such as personal planning, work or family. Thus, class books are made for graduated students, such that they can keep in contact with each other after their graduation. A traditional class book generally includes photos of teachers and students and correspondence data of the students. However, these class books incur a cost, and the content of the class book may change due to personal factors, and the change of information cannot be updated with time. As a result, the students may be unable to keep in touch as often, or they may even lose contact with each other.

Therefore, it is a main subject for the invention to develop an electronic class system to save students' expenses and allows students to update their correspondence information and keep in contact with each other anytime.

### SUMMARY OF THE INVENTION

In view of the aforementioned shortcomings of the conventional class system, the inventor of the present invention based on years of experience in the related industry to conduct extensive researches and experiments, and finally developed an electronic class system, in hope of saving students' expenses and allowing students to update their correspondence information and keep in contact with each other anytime.

Therefore, it is a primary objective of the present invention to overcome the aforementioned shortcomings and deficiencies of the prior art by providing an electronic class system, and the electronic system allows data and images of students to be posted and updated anytime, and achieves the effects of saving the student's expenses, updating correspondence data of the students, and allowing students to keep in contact with each other anytime.

To achieve the foregoing objective, the present invention provides an electronic class system comprising: a class certifying unit for certifying a plurality of students of a class; a class information displaying unit for displaying a school name and a grade level of the class; a class student displaying unit for displaying a plurality of student images of the class, wherein the student images are linked to a student information group; and a class message announcing unit for displaying at least one message title.

The student information group includes at least one student personal information, at least one student correspondence information, at least one student message information of the student or any combination of the above.

The electronic class system further comprises a class official displaying unit for displaying a class teacher image, at least one teacher image, or at least one official image of the class or any combination of the above.

The class teacher image is linked to at least one class teacher personal information, at least one class teacher correspondence information, at least one class teacher message information or any combination of the above; the teacher image is linked to at least one teacher personal information, at least one teacher correspondence information, at least one teacher message information or any combination of the above; and the official image is linked to at least one official personal information, at least one official correspondence information, at least one official message information or any combination of the above.

The electronic class system further comprises a class image displaying unit for displaying at least one daily-life image related to the students.

The daily-life image is linked to at least one background information.

The message title is linked to an information content.

Therefore, the electronic class system of the invention can achieve the effects of saving students' expenses, updating correspondence data of the student, and allowing students to keep in contact with each other anytime.

### BRIEF DESCRIPTION OF THE DRAWINGS

FIG. 1 is a schematic view of an electronic class system in accordance with a preferred embodiment of the present invention;

FIG. 2 is a schematic view of a class certifying unit in accordance with a preferred embodiment of the present invention;

FIG. 3 is a schematic view of a student image in accordance with a preferred embodiment of the present invention;

FIG. 4 is a schematic view of an official image in accordance with a preferred embodiment of the present invention;

FIG. 5 is a schematic view of a class teacher image in accordance with a preferred embodiment of the present invention;

FIG. 6 is a schematic view of a teacher image in accordance with a preferred embodiment of the present invention;

FIG. 7 is a schematic view of a daily-life image in accordance with a preferred embodiment of the present invention; and

FIG. 8 is a schematic view of a message title in accordance with a preferred embodiment of the present invention.

### DESCRIPTION OF THE PREFERRED EMBODIMENTS

The objects, characteristics and effects of this invention will become apparent with the detailed description of the preferred embodiments together with the illustration of related drawings as follows.

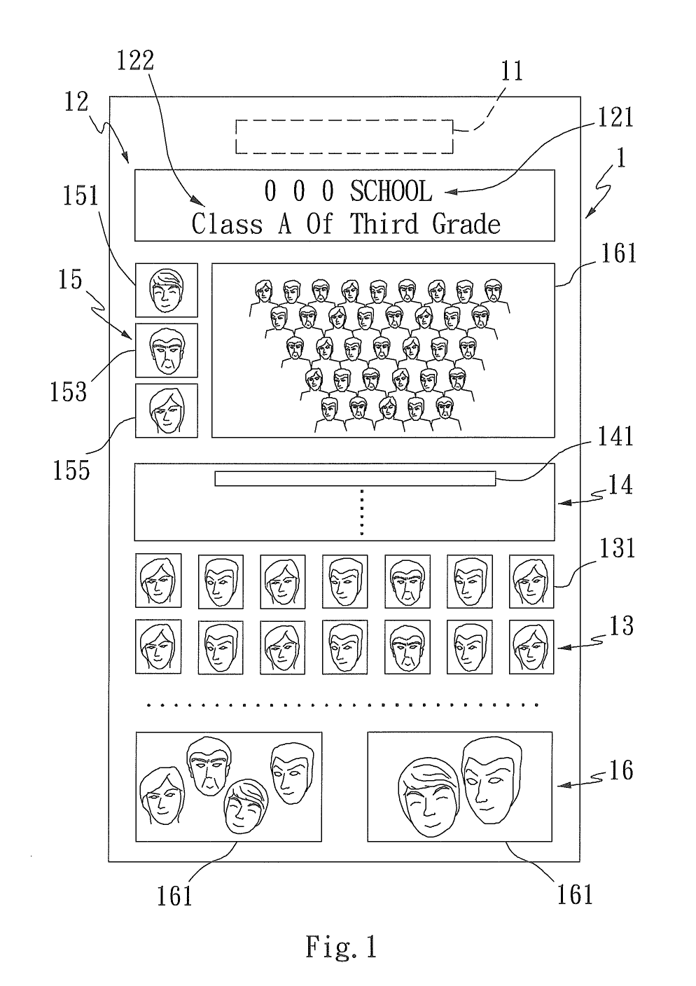

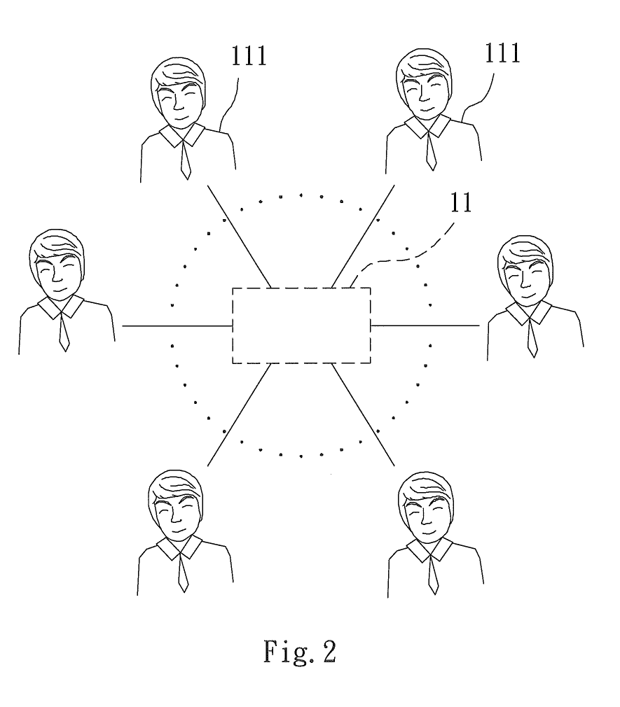

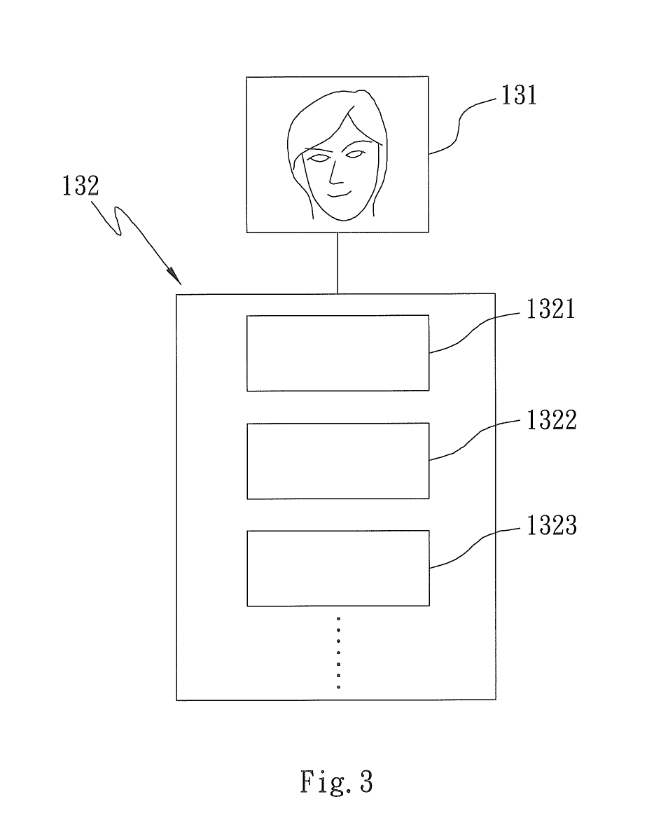

With reference to FIGS. 1 to 3 for schematic views of an electronic class system, a class certifying unit and a student image in accordance with a preferred embodiment of the present invention respectively, the electronic class system 1 comprises a class certifying unit 11, a class information displaying unit 12, a class student displaying unit 13 and a class message announcing unit 14. The class certifying unit 11 is provided for certifying a plurality of students 111 in a class, and the class certifying unit 11 provides a personal account to a student after the student 111 has registered, and the personal account is used for the student 111 to log on and use the electronic class system 1 designated to the student 111. In addition, any person approved by the registered student 111 and certified by the class certifying unit 11 can use the electronic class system 1. The class information displaying unit 12 is provided for displaying a school name 121 and a grade level 122 of the class; the class student displaying unit 13 is provided for displaying a plurality of student images 131 of the class, and the student images 131 are linked to a student information group 132. The class message announcing unit 14 is provided for displaying at least one message title 141, and the class message announcing unit 14 is provided for the students 111 to send messages to other students 111 of the class for their viewing, so as to improve the chance for the students 111 to contact with each other.

The student information group 132 includes at least one student personal information 1321, at least one student correspondence information 1322, or at least one student message information 1323 of the students 111 or any combination of the above, and the student personal information 1321 includes a name, a date of birth, a blood type, a horoscope or a personal profile of the students 111, and the student correspondence information 1322 includes a telephone number, an email address, a website or an address of the students 111, and the student message information 1323 is a message left by the student 111 or a message left by other students 111 to a student 111.

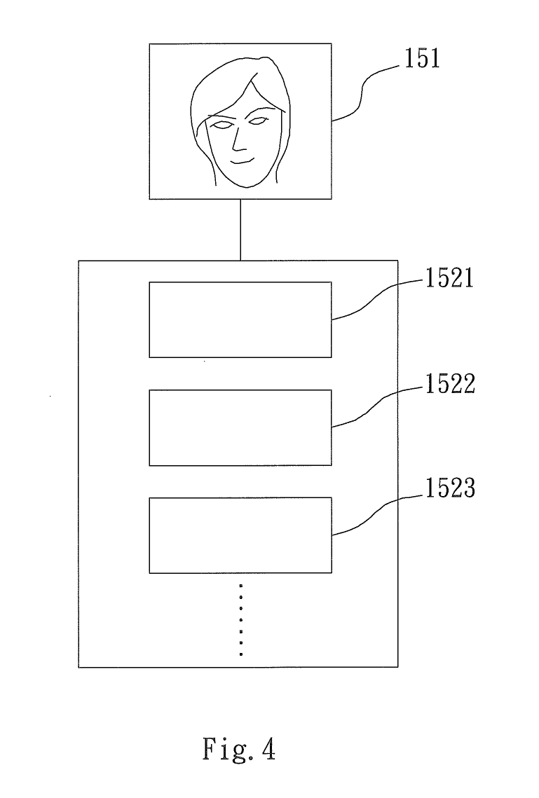

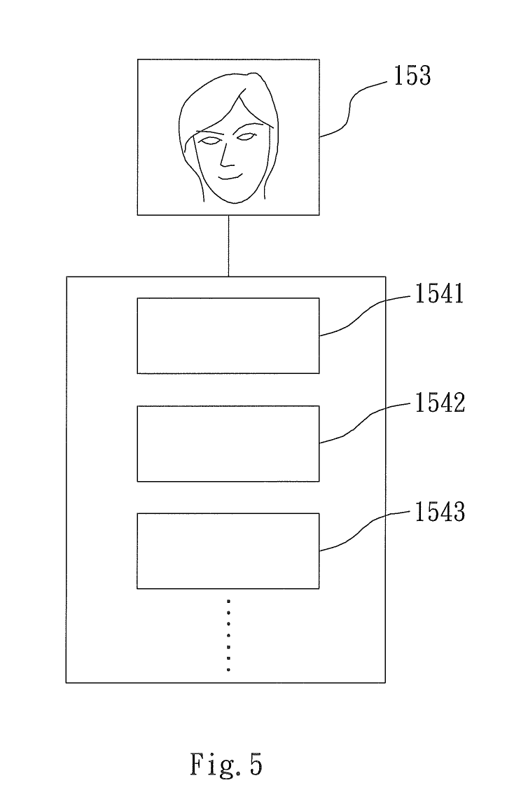

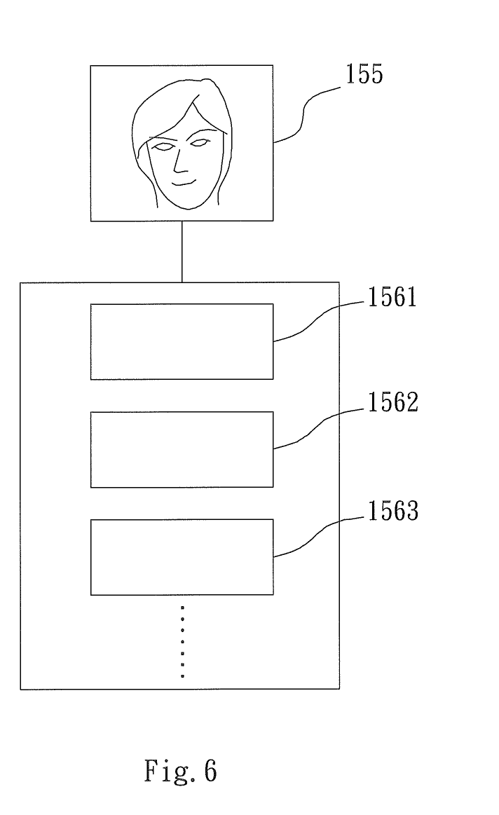

With reference to FIGS. 4 to 6 for schematic views of an official image, a class teacher image and a teacher image in accordance with a preferred embodiment of the present invention respectively, the electronic class system 1 further comprises a class official displaying unit 15 for displaying a class teacher image 153, at least one teacher image 155, or at least one official image 151 of the class, or any combination of the above, wherein the official image 151 is a principal image, a vice principal image, or an academic dean image, and the teacher image 155 is a Chinese teacher image, an English teacher image, or a mathematics teacher image, and the class official displaying unit 15 can improve the chance for the students 111 and the officials to contact with each other.

The class teacher image 153 is linked to at least one class teacher personal information 1541, at least one class teacher correspondence information 1542, at least one class teacher message information 1543 or any combination of the above, wherein the class teacher personal information 1541 includes a name, a date of birth, a blood type, a horoscope or a personal profile of the class teacher, and the class teacher correspondence information 1542 includes a telephone number, an email address, a website or an address of the class teacher, and the class teacher message information 1543 is a message left by the class teacher or a message left by others students 111 to the class teacher. The teacher image 155 is linked to at least one teacher personal information 1561, at least one teacher correspondence information 1562, at least one teacher message information 1563 or any combination of the above, wherein the teacher personal information 1561 includes a name, a date of birth, a blood type, a horoscope or a personal profile of the teacher, and the teacher correspondence information 1562 includes a telephone number, an email address, a website or an address of the teacher, and the teacher message information 1563 is a message left by the teacher or a message left by other students 111 to the teacher. The official image 151 is linked to at least one official personal information 1521, at least one official correspondence information 1522, at least one official message information 1523 or any combination of the above, wherein the official personal information 1521 includes a name, a date of birth, a blood type, a horoscope or a personal profile, and the official correspondence information 1522 includes a telephone number, an email address, a website or an address of the official, and the official message information 1523 is a message left by the official or a message left by other students 111 to the official.

The electronic class system 1 further comprises a class image displaying unit 16 for displaying at least one daily-life image 161 related to the students 111, such as displaying the images of all graduated students, daily-life images of a student, or images provided by a student and shared with others. Since the class image displaying unit 16 can share images among the students 111, therefore the students 111 have a better chance of getting in touch with each other.

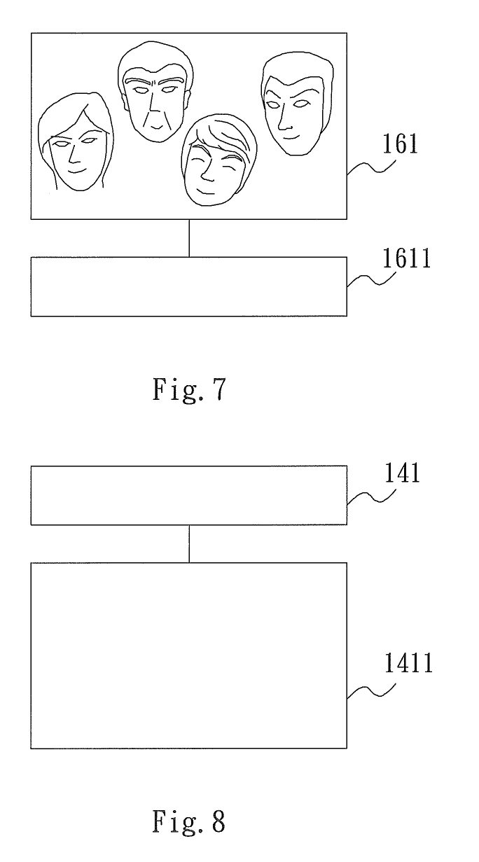

With reference to FIG. 7 for a schematic view of a daily-life image in accordance with a preferred embodiment of the present invention, the daily-life image 161 is linked to at least one background information 1611, wherein the background information 1611 is a message provided by the provider of the daily-life image 161 or a message provided by another student 111, and the background information 1611 can improve the chance for the students 111 to contact with each other.

With reference to FIG. 8 for a schematic view of a message title in accordance with a preferred embodiment of the present invention, the message title 141 is linked to an information content 1411, and the information content 1411 describes the message title 141 in details, and the information content 1411 improves the chance for the students 111 to contact with each other.

The texts and images included in the electronic class system 1 can be static or dynamic to give variations to the electronic class system 1. In addition, the electronic class system 1 can be provided for the use by current students or graduated students, and thus the electronic class system 1 can be used more extensively.

In summation of the description above, the present invention provides an electronic system to post and update data and images of students anytime, so as to achieve the effects of saving expenses of the students, updating correspondence data of the students, and allowing the students to keep contact with each other anytime. In addition, the products of the invention meet the market requirements, and the present invention complies with patent application requirements, and thus the invention is duly filed for patent application.

While the invention has been described by means of specific embodiments, numerous modifications and variations could be made thereto by those skilled in the art without departing from the scope and spirit of the invention set forth in the claims.

What is claimed is:

1. An electronic class system, comprising:
a class certifying unit, for certifying a plurality of students in a class;
a class information displaying unit, for displaying a school name and a grade level of the class;
a class student displaying unit, for displaying a plurality of student images of the class, and the student images being linked to a student information group; and
a class message announcing unit, for displaying at least one message title.

2. The electronic class system of claim 1, wherein the student information group includes at least one student personal information, at least one student correspondence information, or at least one student message information of the students, or any combination of the above.

3. The electronic class system of claim 1, further comprising a class official displaying unit, for displaying a class teacher image, at least one teacher image, or at least one official image of the class, or any combination of the above.

4. The electronic class system of claim 2, further comprising a class official displaying unit, for displaying a class teacher image, at least one teacher image, or at least one official image of the class, or any combination of the above.

5. The electronic class system of claim 3, wherein the class teacher image is linked to at least one class teacher personal information, at least one class teacher correspondence information, at least one class teacher message information, or any combination of the above; the teacher image is linked to at least one teacher personal information, at least one teacher correspondence information, at least one teacher message information or any combination of the above; and the official image is linked to at least one official personal information, at least one official correspondence information, at least one official message information or any combination of the above.

6. The electronic class system of claim 4, wherein the class teacher image is linked to at least one class teacher personal information, at least one class teacher correspondence information, at least one class teacher message information or any combination of the above; the teacher image is linked to at least one teacher personal information, at least one teacher correspondence information, at least one teacher message information or any combination of the above; the official image is linked to at least one official personal information, at least one official correspondence information, at least one official message information or any combination of the above.

7. The electronic class system of claim 1, further comprising a class image displaying unit for displaying at least one daily-life image related to the students.

8. The electronic class system of claim 2, further comprising a class image displaying unit for displaying at least one daily-life image related to the students.

9. The electronic class system of claim 7, wherein the daily-life image is linked to at least one background information.

10. The electronic class system of claim 8, wherein the daily-life image is linked to at least one background information.

11. The electronic class system of claim 1, wherein the message title is linked to an information content.
